(19) United States
(12) Patent Application Publication
(10) Pub. No.: US 2022/0162107 A1
(43) Pub. Date: May 26, 2022

(54) Water Purification Apparatus, Purification Module Therefor and Method

(71) Applicant: Brightman Water Limited, Dartford (GB)

(72) Inventor: Jeremy George Hazard Hassell, Grayshott, Hampshire (GB)

(73) Assignee: Brightman Water Limited, Dartford (GB)

(21) Appl. No.: 17/599,605

(22) PCT Filed: Mar. 20, 2020
(86) PCT No.: PCT/GB2020/050754

§ 371 Date: Sep. 29, 2021

(30) Foreign Application Priority Data
Mar. 29, 2019 (GB) 1904475.9

(51) Int. Cl. C02F 9/00

(52) U.S. Cl. CPC C02F 9/005; C02F 1/283; C02F 2201/004; C02F 2201/007

(57) ABSTRACT

A water purification apparatus (10) is provided for dispensing pure water which comprises a main apparatus body (12) having at least one main fluid inlet (26) and at least one main fluid outlet (28), and a dispensing element (20) for dispensing pure water from the water purification apparatus (10). A purification module (18) is then also provided which is releasably engagable with the main apparatus body (12). This purification module (18) comprises a plurality of water purification sub-modules, an inlet manifold (76a) in fluid communication with (lie plurality of water purification sub-modules and which is connectable to the at least one main fluid outlet (28) of the main apparatus body (12), and an outlet manifold (76b) which is fluidly engagable with the dispensing element (20).

### CROSS-REFERENCE TO RELATED APPLICATIONS

This application is a national phase entry under 35 U.S.C. § 371 of International Application PCT/GB2020/050754, filed Mar. 20, 2020, which claims priority to GB Patent Application No. 1904475.9, filed Mar. 29, 2019, all of which are herein incorporated by reference in their entirety.

### TECHNICAL FIELD

The present invention relates to a water purification apparatus, particularly but not necessarily exclusively for dispensing pure water for laboratory use. A method of regenerating such an apparatus is also provided, as is a purification module suitable for use with, or for retrofitting into existing, water purification apparatuses. A method of reducing waste components of an existing water purification apparatus, and an improved water purification apparatus are also provided.

### BACKGROUND

Pure and ultrapure water are used in a variety of contexts, particularly in the scientific and medical laboratory context. Pure and ultrapure water have contaminants and impurities removed to as great a degree as is possible. The difficulty with the provision of pure water is in the prevention of contamination within whatever receptacle the water is contained, for instance via leaching from storage materials or atmospheric contact, or by contamination from transfer between the storage container and the use.

Existing units for producing pure and ultrapure water therefore use sealed container units, and filtration and purification of the inlet water occurs in the same unit. Purification cartridges are supplied which can be used in a plug-and-play manner; whenever a cartridge is spent, it can be replaced with a fresh cartridge to ensure that pure water can still be produced, and the spent cartridge disposed of Typically, spent cartridges are sent to landfill, which is incredibly wasteful.

There are many other deficiencies with existing water purification apparatuses. Firstly, it is not uncommon for the purity of the water to be measured, typically measured by determining the conductance of the water in microsiemens and Megohms, at the point of purification. However, subsequent transfer and storage of the purified water following purification can result in higher levels of impurities than displayed to the user, which may therefore be misleading where ultrapure water is required.

Furthermore, disinfection of the water purification apparatuses must be performed on a regular basis. This is achieved in the art by the use of chlorine tablets which are handled by technicians and inserted into the apparatus. This leads to additional routes for entry of atmospheric contaminants into the apparatus, which can lead to lower purity water in due course. Chlorine in the system also causes damage to reverse osmosis membranes which are used as part of the purification system, and therefore chlorine disinfection produces a risk of seriously damaging the whole apparatus.

The present invention seeks to provide an improved water purification apparatus which can ensure that a user is able to extract water of the correct purity, whilst also eliminating the excessive waste created by the current water purification industry.

### SUMMARY

According to a first aspect of the invention, there is provided a water purification apparatus for dispensing pure water, the water purification apparatus comprising: a main apparatus body having at least one main fluid inlet and at least one main fluid outlet; a dispensing element for dispensing pure water from the water purification apparatus; and a purification module which is releasably engagable with the main apparatus body, the purification module comprising a plurality of water purification sub-modules, a support framework, an inlet manifold in fluid communication with the plurality of water purification sub-modules and which is connectable to the at least one main fluid outlet of the main apparatus body, and an outlet manifold which is fluidly engagable with the dispensing element wherein at least one of the plurality of water purification sub-modules is provided having a modular construction, comprising a removable vessel into which purification media can be inserted, and the or each removable vessel being mounted to and sealed via the support framework.

The provision of a water purification apparatus which has a removable purification module containing all of the relevant components required to generate pure or ultrapure water from potable or distilled water allows for simple alteration of the apparatus to suit a user's need. The entire purification module can be removed as one and then recycled or regenerated. This has two primary advantages. Firstly, the huge amount of waste created by the disposal of spent filtration cartridges in existing water purification apparatuses is reduced to almost nil. Secondly, the purification module can be filled with a bespoke purification medium arrangement, which means that the purification process can be easily tailored to the user's requirements without them needing to purchase additional apparatuses.

Preferably, the plurality of water purification sub-modules may comprise at least two of: an activated carbon sub-module; a reverse osmosis sub-module; an ion-exchange sub-module; an ultra-filtration sub-module; a UV lamp sub-module.

Many purification sub-modules can be provided as part of the overall purification module, and by providing lots of different options, the user can create a bespoke purification assembly for their task without requiring several different apparatuses for each task.

Optionally, the purification module may comprise a first purification sub-module sequence and a second purification sub-module sequence.

It is preferred that there is one rough purification sequence for purifying inlet water, typically from a mains water network, and a second, more polished, recirculation sequence which maintains the purity of the water over an extended period of time, so that the user has confidence in the expected water purity on dispensation.

In one preferred embodiment, the first purification sub-module sequence may comprise a plurality of said water purification sub-modules in the sequence of: an activated carbon sub-module; a first reverse osmosis sub-module; and a second reverse osmosis sub-module.

Reverse osmosis provides an initial and powerful filtration option, whilst the adsorption capabilities of the activated carbon sub-module prevent chlorine disinfectant damage to the reverse osmosis membranes.

The second purification sub-module sequence may comprise a plurality of said water purification sub-modules in the sequence of: an activated carbon sub-module; and at least one ion-exchange sub-module.

Ion exchange provides a means of extracting any extraneous ions which may be present in the purified water which may not otherwise have been removed via reverse osmosis. This ensures that pure water is maintained over long periods of time.

Furthermore, the second purification sub-module sequence may comprise a UV lamp sub-module; and an ultra-filtration sub-module.

UV treatment ensures that there is no potential for bacterial build-up in the water over time, whilst ultrafiltration can assist with removing additional particulate matter which may not have been caught during reverse osmosis.

Preferably, the second purification sub-module sequence may form a recirculation loop.

Recirculation further ensures that there is no degradation in water purity over time, which might otherwise occur with water in a stagnant reservoir.

Preferably, there may be further provided a water reservoir which is in fluid communication with the recirculation loop.

The provision of a reservoir allows for pure water to be held, with the recirculation loop preventing increased contamination over a long period of time, for instance, via dust ingress or material leaching.

The water purification apparatus may further comprise an air vent filter engagable with a top of the water reservoir, wherein the air vent filter comprises a chlorine tablet scoop.

An air vent filter is appropriate for preventing contamination as the water reservoir becomes depleted. This also provides a neat mechanism by which a user can introduce disinfecting chlorine tablets without themselves touching the chlorine tablet. This limits a contamination pathway.

The water purification apparatus may further comprise a direct dispensing adaptor downstream of the outlet manifold for extraction of pure water following purification via the purification module.

Whilst a nozzle dispenser is the traditional method of dispensing water in the art, this increases the contact of the water with the atmosphere, potentially immediately contaminating the water. For ultrapure requirements, it may therefore be preferred to directly transfer the pure water into an end vessel or transfer means.

Preferably, the direct dispensing adaptor may comprise at least one injection Luer connector.

An injection Luer connection allows for a sterile and uncontaminated syringe to be used to extract the ultrapure water from the apparatus, significantly reducing the risk of contamination by the technician in particular.

Optionally the purification module may comprise a casing which encloses each of the plurality of water purification sub-modules.

The purification module is designed to be a unit which can be readily removed from the main apparatus body, and therefore an outer casing enclosing the sub-modules allows for the unit to be extracted and returned to a main centre for recycling or regenerating very easily. In the meantime, a bespoke replacement module can be provided to the user.

The purification module may include a cassette having a plurality of vessels for supporting the plurality of water purification sub-modules.

A stacked cassette arrangement allows for the ready introduction and removal of the purification module, and holds the sub-modules in a safe and sturdy manner.

Optionally, there may be provided an electrolysis module which is fluidly communicable with the water reservoir, the electrolysis module being configured to generate chlorine for disinfection of the water purification apparatus.

Introduction of chlorine tablets into the water reservoir of existing water purification apparatuses is one of the largest sources of contamination, primarily via the technician. An integrated electrolysis module would obviate this issue, since this could be readily remotely activated by the user via a control panel.

In one embodiment, there may be further provided a peristaltic pump associated with the dispensing element for metering pure water from the water purification apparatus.

A peristaltic pump provides for very accurate metering of water for dispensing, without providing any direct contact with the ultrapure water itself. This is therefore a preferred pumping configuration, particularly where the injection Luer connectors are used.

A hot water reservoir may be provided, the hot water reservoir being fluidly communicable with the water purification apparatus to permit thermal sanitisation thereof.

As noted, chlorine tablets are not only a source of potential contamination, but also can cause significant damage to reverse osmosis membranes if not effectively scrubbed by an activated carbon sub-module. A hot water tank is capable of thermal sanitisation, thereby removing the need for chemical disinfection completely, though the apparatus does then require more heavy-duty thermally resistant conduits to be used.

Optionally, the water purification apparatus may further comprise a manifold adaptor which is insertable to connect the or each main fluid outlet of the main apparatus body and the inlet manifold of the purification module.

A simple adaptor for connecting the purification module and main apparatus body is one way of ensuring that the module replacement process is quick and easy.

The water purification apparatus may further comprise a cooling manifold in the water purification apparatus.

Cooling manifolds, particularly where concentrates from reverse osmosis can be recycled for this purpose, allows for the apparatus to be kept thermally stable in hot laboratory conditions. This is particularly useful in hotter countries.

The purification module may be releasably engagable with a front of the main apparatus body.

Positioning of the purification module at the front of the apparatus allows for simple removal of the module, making for a straightforward replacement where a different module configuration is required.

Preferably, the water purification apparatus may comprise one or more locators on or at the support framework for mounting the removable vessels.

Preferably, the support framework may comprise at least one plate for sealing all of the removable vessels in position in the purification module.

According to a second aspect of the invention, there is provided a method of regenerating a water purification apparatus in accordance with the first aspect of the invention, the method comprising the steps of: a] removing the purification module from the main apparatus body; b] recycling or regenerating each of the plurality of water purification sub-modules; and c] re-attaching the or another said purification module to the main apparatus body.

Existing water purification apparatuses have an extreme approach to the disposability of the filtration and purification cartridges. The present invention allows for recycling and regeneration of the apparatus to eliminate this waste.

Optionally, during step b], for each of the plurality of water purifications sub-modules, comprises the sub-steps of: b1] a purification medium is removed from a sub-module vessel; b2] the purification medium is regenerated or recycled; b3] the sub-module vessel is cleaned and sterilized; and b4] the plurality of water purification sub-modules are reassembled by insertion of regenerated or recycled purification medium into the respective sub-module vessels.

The ability to individually clean the vessels in which the purification media are held not only enables the regeneration procedure, but also allows for bespoke purification pathways to be produced based on an individual user's requirements.

According to a third aspect of the invention, there is provided a purification module for a water purification apparatus, the purification module comprising: a plurality of water purification sub-modules, wherein at least one of the plurality of water purification sub-modules is provided having a modular construction, comprising a removable vessel into which purification media can be inserted; a support framework, the or each removable vessel being mounted to and sealed via the support framework; an inlet manifold in fluid communication with the plurality of water purification sub-modules and which is connectable to at least one main fluid outlet of a main apparatus body of a water purification apparatus; and an outlet manifold which is adapted to be fluidly engagable with a dispensing element of the water purification apparatus.

The use of a dedicated purification module enables the change in the way in which water purification apparatuses are utilised to be achieved. Rather than providing disposable cartridges, the present invention allows for the module as a whole to be extracted and recycled or regeneration. Additionally, this arrangement may allow for retrofitting of an updated purification module to existing water purification apparatuses, thereby eliminating existing sources of waste.

According to a fourth aspect of the invention, there is provided a method of reducing waste components of an existing water purification apparatus, the method comprising the steps of: a] providing a purification module in accordance with the third aspect of the invention; b] directly or indirectly connecting the inlet manifold of the purification module to the or each main fluid outlet of the main apparatus body of the water purification apparatus; and c] recycling or regenerating each of the plurality of water purification sub-modules when a purity of output purified water from the water purification apparatus falls below a predetermined threshold.

The ability to reduce the waste generated by water purification apparatuses is a significant leap for the present invention, and therefore can allow for a much more environmentally-friendly approach to water purification for laboratory purposes to be considered.

According another aspect of the invention, there is provided a water purification apparatus for dispensing pure water, the water purification apparatus comprising: at least one main fluid inlet; a purification assembly which is in fluid communication with the or each main fluid inlet; a dispensing element for dispensing pure water from the water purification apparatus; a fluid pump for circulating water into the purification assembly to generate pure water for dispensation via the dispensing element; and a direct dispensing adaptor comprising at least one injection Luer connector downstream of the purification assembly to permit controlled withdrawal of purified water therefrom.

The use of a direct dispensing adaptor comprising an injection Luer connector allows for controlled withdrawal of purified water with minimal contact with the atmosphere, which would otherwise represent a contamination hazard. This ensures that the user can confidently know that their water is sufficiently pure for their application.

Optionally, the water purification apparatus may further comprise at least one water purity sensor, wherein a probe of the or each water purity sensor is positioned downstream of the purification assembly.

The addition of a sensor to indicate water purity, typically via conductivity measurements, ensures that the user has confidence in the water purity at the point of use, which has been lacking in the industry to date.

### BRIEF DESCRIPTION OF THE DRAWINGS

The invention will now be more particularly described, by way of example only, with reference to the accompanying drawings, in which:

FIG. 1 shows a front perspective representation of one embodiment of a water purification apparatus in accordance with the first aspect of the invention;

FIG. 2 shows an exploded front perspective representation of the main apparatus body and manifold adaptor of the water purification apparatus of FIG. 1, with the purification module removed for clarity;

FIG. 3 shows a rear perspective representation of the main apparatus body of the water purification apparatus of FIG. 1, with an upper casing removed for clarity;

FIG. 4 shows a front perspective representation of the purification module of the water purification apparatus, in accordance with the third aspect of the invention, with the outer casing removed for clarity;

FIG. 5 shows a front perspective representation of a first assembly stage of the purification module of FIG. 4;

FIG. 6 shows a front perspective representation of a second assembly stage of the purification module of FIG. 4;

FIG. 7 shows a front perspective representation of a third assembly stage of the purification module of FIG. 4;

FIG. 8 shows a front perspective representation of a fourth assembly stage of the purification module of FIG. 4;

FIG. 9 shows a rear perspective representation of the water purification sub-modules of the purification module of FIG. 4;

FIG. 10 shows a front representation of the purification module of FIG. 4;

FIG. 11 shows a front perspective representation of the purification module of FIG. 4 in a fully assembled state;

FIG. 12 shows a perspective representation of a water reservoir compatible with the water purification apparatus of FIG. 1;

FIG. 13 shows a front perspective representation of the air vent filter of the water purification apparatus of FIG. 1;

FIG. 14 shows a perspective representation of an injection Luer connector of the water purification apparatus of FIG. 1; and

FIG. 15 shows a top representation of an electrolysis module compatible with the water purification apparatus of FIG. 1.

### DETAILED DESCRIPTION

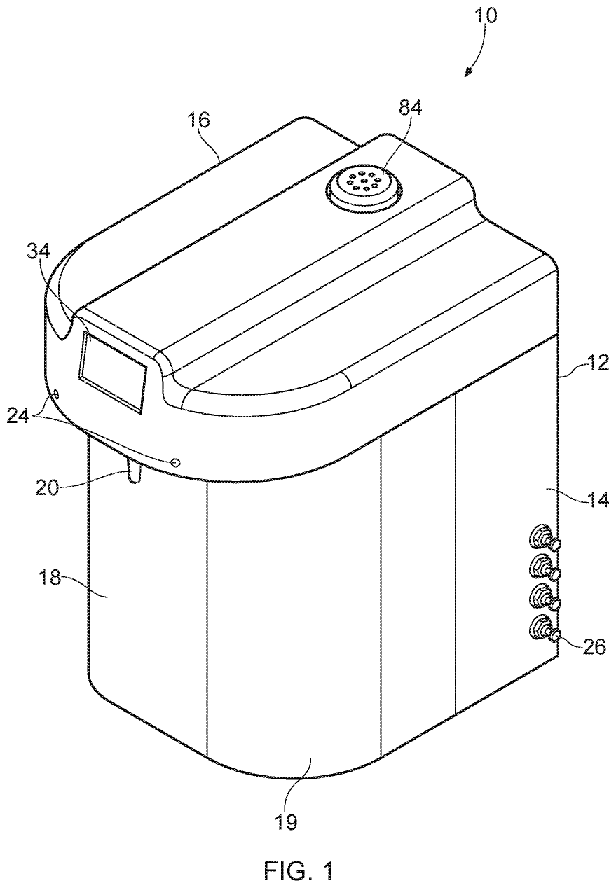

Referring to FIG. 1, there is indicated a water purification apparatus, indicated globally at 10, which is suitable for the generation of pure, and more preferably ultrapure, water particularly for scientific laboratory use.

In the present invention pure water is defined as water which has been filtered and/or processed to remove impurities by any one of a variety of means. This is often referred to as distilled water for scientific use, and is distinct from standard potable water such as drinking water or ground water. Ultrapure water is of such high purity that its trace contaminants are measured in parts per billion, and has a theoretical minimum conductivity of around 0.055 μS/cm at 25° C., equivalent to 18MΩcm. In this scenario, conductivity is provided solely by H⁺ and OH⁻ ions produced in water dissociation equilibrium. In practice, conductivities of the order of 10 μS/cm at 25° C. would be sufficient for classification as ultrapure water.

The water purification apparatus 10 comprises a main apparatus body 12, here having a rear housing unit 14 and a top cap 16 which covers the electronic components of the water purification apparatus 10, and a purification module 18 which is releasably engagable with the rear housing unit 14, preferably via a support platform 19 thereof.

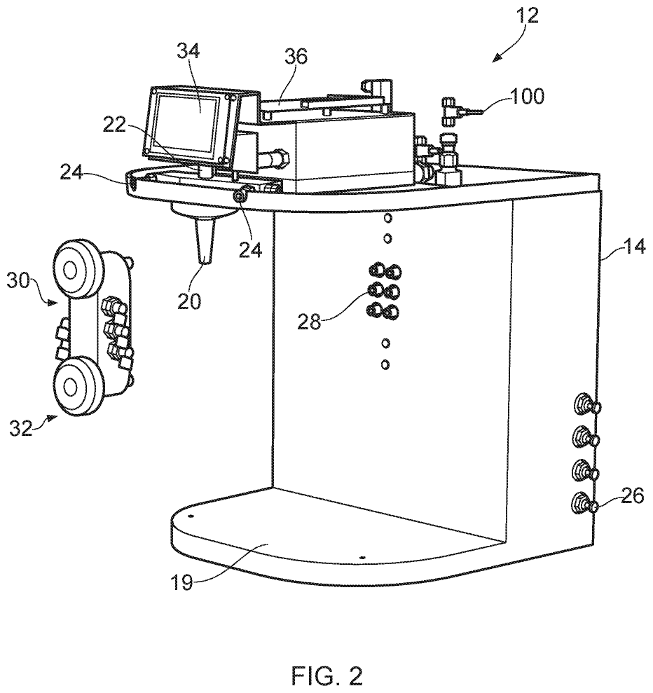

Water purification is achieved via the purification module 18, and comprises a plurality of, preferably different, water purification sub-modules therein, which will be discussed in more detail later on. Water purified by the purification module 18 can then be dispensed through a dispensing element 20, such as a nozzle. Preferably, the dispensing element 20 is associated with a peristaltic pump to allow accurate metering of dispensed water without introducing further contaminants. However, the present water purification apparatus 10 may also include a direct dispensing adaptor 22, as can be seen in FIG. 2, which includes at least one injection Luer connector 24 which is accessible from the main apparatus body 12. Whilst a Luer connector is preferred, any appropriate receiver for engagement with a sealed extraction system, typically a syringe, could be utilised in order to overcome the issue of exposure of dispensed water to the air.

The main apparatus body 12 includes one or more main fluid inlets 26, via which potable water for purification can be introduced to the water purification apparatus 10. Such main fluid inlets 26 may be readily accessible from the outside of the main apparatus body 12, and are positioned on a side thereof in the indicated embodiment.

FIG. 2 shows the main apparatus body 12 without the purification module 18. This illustrates the main fluid outlets 28 of the main apparatus body 12 which are fluidly connectable to the purification module 18. In this instance, there is only indirect coupling to the purification module 18, and a manifold adaptor 30 is provided which is insertable to connect to the or each main fluid outlet 28. The manifold adaptor 30 may be provided with oversized fasteners 32 which allow for ready screw-threaded mounting to the main apparatus body 12.

The direct dispensing adaptor 22 can also be seen in more detail in FIG. 2, being a splitter which directs fluid flow to the injection Luer connectors 24 downstream of the purification module 18. It is here positioned at or adjacent to the dispensing element 20 for simplicity, but the direct dispensing adaptor 22 could be easily positioned immediately following the purification module 18 to ensure that there is minimum post-purification contamination of purified water.

The water purification apparatus 10 may also include a control panel 34 via which commands may be input, and this is here provided as a touchscreen panel. The control panel 34 is in communication with the controller 36 of the whole water purification apparatus 10.

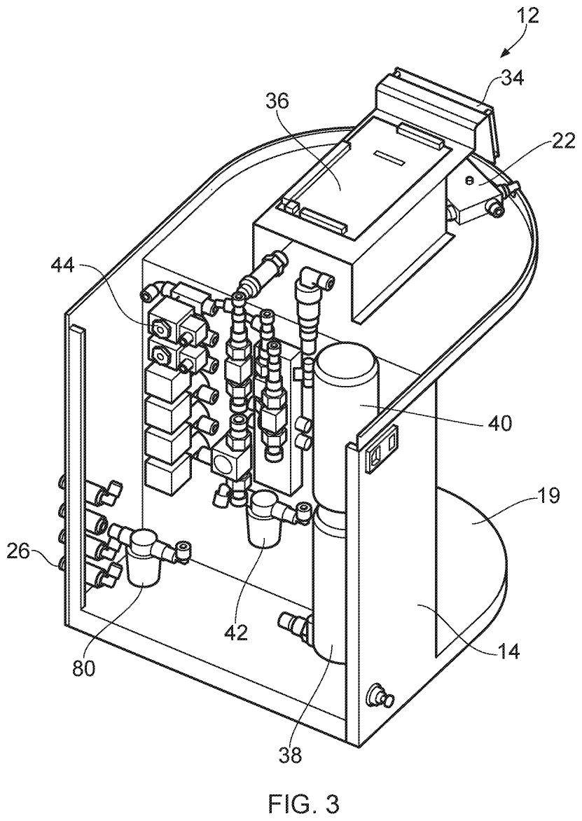

Water is distributed through the water purification apparatus 10 via a recirculation pump 38, which may be accompanied by a boost pump 40 to improve pumping capabilities as necessary. The boost pump 40 may assist with pressurising the system to around 6 bar. These components are shown in detail in FIG. 3, which also illustrates the main-body side pipe manifold.

An inlet strainer 42 is provided as part of the pipe manifold, via which inlet potable water from the or each main fluid inlet 26 passes before entering an inlet valve, preferably an inlet solenoid valve. This acts to prevent suspended solids or particulates interfering with an inlet solenoid seal or entering the purification module 18.

Preferably, the inlet solenoid valve is provided as a brass solenoid valve, where potable water is introduced via the or each main fluid inlet 26; however, more corrosion-resistant valves may be utilised, such as stainless-steel valves, where demineralised inlet water is utilised. At this point, the boost pump 40 may be utilised to pressurise the system.

A plurality of sensors 44 are also illustrated, here in the form of line cell chambers, which are able to measure the resistivity of the water and present this to the control panel 34 for display to the user. It is preferred that the sensors 44 are positioned so as to monitor water close to the point of dispensation, in order to give the user an accurate indication of water purity.

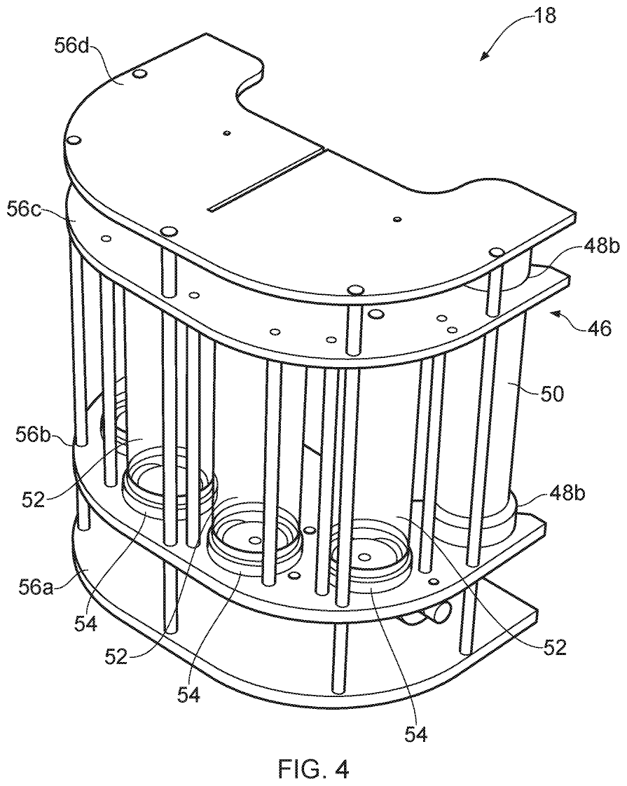

FIG. 4 shows the assembly of the purification module 18. A support framework 46, formed as a multi-storey cassette, is provided for positioning the various water purification sub-modules in the correct configuration for optimum purification.

To provide modularity, there are some locators 48a, 48b for insertable units, typically reverse osmosis and/or ultrafiltration sub-modules 50. However, for ease of regeneration and recycling, it is preferred that at least some of the sub-modules are provided having a modular construction, with removable vessels 52 or chambers being provided into which purification media can be inserted.

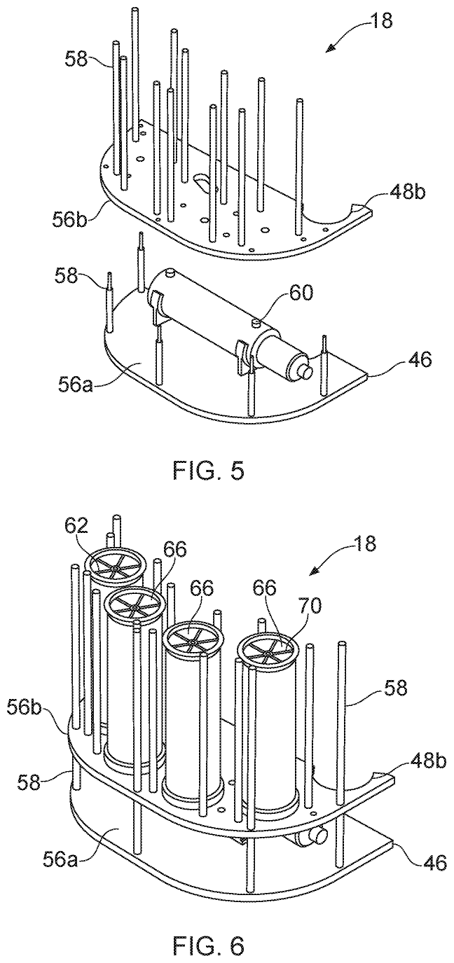

Each vessel 52 is designed to be mounted to, and preferably held in place by, the support framework 46, and in this instance, the mounting is provided by the presence of, preferably, sintered discs 54 which are moulded or positioned at each end of the vessel 52. Alternative locators for the vessels 52 could be considered, including but not limited to moulding locators directly into the support framework 46, and other possible means could be provided to assist with locating the vessels 52 in place. Specific seals may be used to prevent or inhibit egress of the purification media and/or water to be purified, for example, low-leaching O-rings. These seals could be provided as part of, or held in place by, the support framework 52. The assembly, and by extension disassembly, of the purification module 18 is detailed in FIGS. 5 to 8.

Firstly, as shown in FIG. 5, a base plate 56a of the support framework 46 is provided, forming the base of the purification module 18. A plurality of spacers 58 may then be provided to support an intermediate shelf 56b of the support framework 58. The base plate 56a may be used to support at least one of the water purification modules. In the present embodiment, this is actually used to support a UV lamp sub-module 60, which may be primarily used for disinfection of the water purification apparatus 10. This may be mounted in a horizontal configuration, for instance, by the use of Maclow clips for simple insertion and removal.

The intermediate shelf 56b acts to support the modular vessels 52, as illustrated in FIG. 6, and the spacers 58 of this level of the support framework 46 may be dimensioned to match or substantially match the height of the vessels 52. The sintered discs 54, inclusive of any seals associated therewith, may be positioned onto the intermediate shelf 56b. However, the vessels 52 could be mounted to any part of the support framework 46 so as to hold the vessels 52 in place in a sealed arrangement. Precise positioning of the sintered discs 54 may be achieved by the use of a positioning jig which lowers the assembled sealing units comprising the sintered discs 54 and any accompanying seals, into position on the intermediate shelf 56b.

Once the vessels 52 are securely positioned, then purification media may be introduced, such as carbon 62, for example coconut carbon or a similar activated carbon or other material to act as an activated carbon sub-module 64, or an ion-exchange material 66, thereby forming an ion-exchange sub-module 68. Each vessel 52 may then be capped with a sealing cap 70. The sealing cap 70 can hold the purification medium in place whilst permitting water ingress into the vessel 52. Such sealing caps 70 may be formed as sintered top discs, again, having appropriate seals, such as non-leaching O-rings.

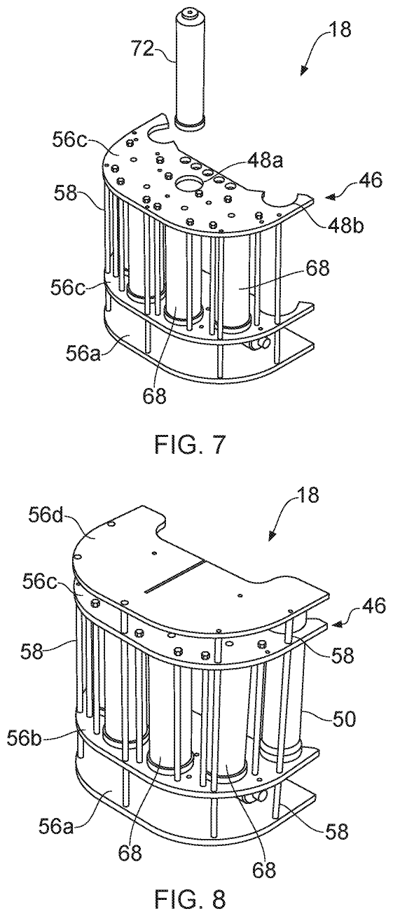

Once all of the vessels 52 are assembled, an intermediate top-shelf 56c can be connected to the spacers 58 so as to seal all of the vessels 52 and hold then securely in position in the purification module 18. The compression provided by the part of the support framework 46, usually a plate such as the intermediate top-shelf 56c, provides the securing force to hold and seal the vessels 52. The intermediate top-shelf 56c may advantageously include the locators 48a, into which additional sub-modules can be inserted; a high-pressure carbon filter 72 is shown being installed in FIG. 7. The locators 48a may serve to restrict the lateral movement of the sub-module installed therein, here being formed as tightly-dimensioned apertures.

Once any central sub-modules are installed, a top plate 56d can be installed to ensure that the sub-modules are securely fitted, as is shown in FIG. 8. The top plate 56d may or may not be directly in contact with the vessels 52 to provide the securing force. The top plate 56d is fitted via spacers 58, similar to those connected to the base plate 56a. Additional locators 48b, here formed as open apertures, may be provided to allow for lateral insertion of further sub-modules, such as the reverse osmosis and/or ultrafiltration sub-modules 50 previously discussed.

The assembly of the purification module 18 allows for a plurality of replaceable vessels 52 or chambers to be introduced, and the purification media therein selected in a bespoke manner, as a unit. The purification module 18 is assembled so that a plurality, and preferably all, of the vessels 52 are sealed using a single plate or portion of the support framework 46. This advantageously allows for the provision of a purification module 18 which can be supplied as a single unit, rather than one which has interchangeable disposable cartridges.

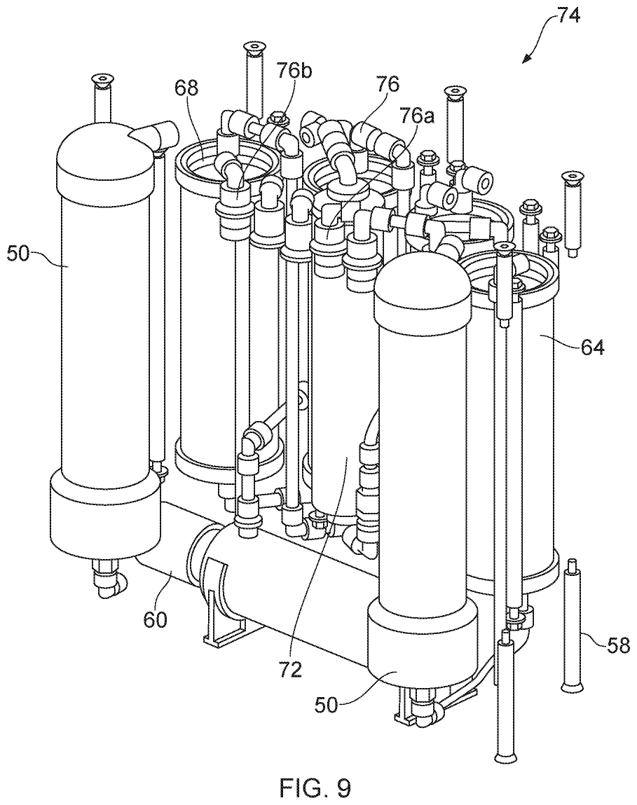

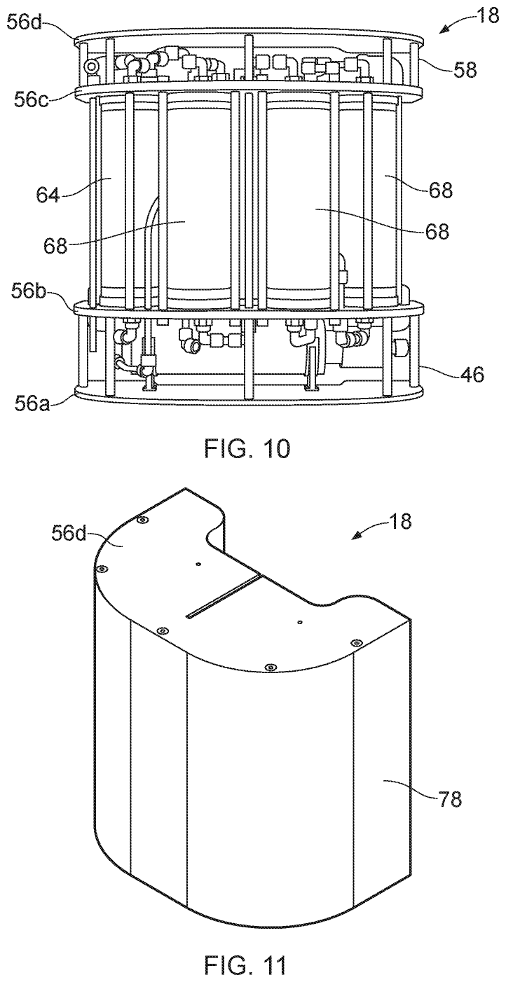

An indicative arrangement of the purification assembly 74 of the purification module 18 without the support framework 46 can be seen in FIG. 9, and illustrates the complex pipe manifold 76 thereof. The fully assembled purification assembly 74 can be seen inclusive of the support framework 46 in FIG. 10. At least one of the pipes of the pipe manifold 76 will nominally be part of an inlet manifold 76a which is fluidly communicable with the main fluid outlet 28. This may be achieved via interconnection with the manifold adaptor 30, as previously discussed.

A further at least one of the pipes of the pipe manifold 76 may be nominally part of an outlet manifold 76b, via which purified water from the purification module 18 is output. Again, the outlet manifold 76b may be connected to the manifold adaptor 30 for onwards supply to the dispensing element 20.

For a complete purification module 18, an outer casing 78 is then required, as can be seen in FIG. 11. This allows the end user to install and remove the purification module 18 in their water purification apparatus 10, without needing to interfere with the individual water purification sub-modules.

It is intended that the purification module 18 therefore be assembled remotely to the water purification apparatus 10, allowing the manufacturer to readily tailor the purification module 18 in accordance with the end user's water purification requirements. Since this arrangement allows the water purification sub-modules to be regenerated or recycled, an end user does not need to have several different apparatuses in order to produce water to different purity specifications. Instead, the purification module 18 can be exchanged. This opens up a specific business model whereby replacement purification modules 18 can be rapidly shipped to an end user based on changing circumstances, whilst the outgoing purification module 18 is regenerated or recycled. This massively reduces the overall waste production from water purification apparatuses.

Furthermore, it will be appreciated that with an appropriate manifold adaptor 30, the present purification module 18 could be readily retrofitted to existing apparatuses. This may allow existing users to effectively upgrade and enhance their water purification apparatuses to eliminate the waste cartridges.

The purification sequence of the present purification module 18 is as follows. Potable or distilled water is introduced via the inlet manifold 76a of the purification module 18. Firstly, the water is introduced into the activated carbon sub-module 64 at pressure, which is designed to remove any trace of chlorine from the water, which would otherwise damage a reverse osmosis membrane of the reverse osmosis sub-modules 50.

Once the water is dechlorinated, it is passed into the reverse osmosis sub-modules 50. The water enters a first membrane thereof, and is split into two streams. The first stream passes across the membrane under pressure, allowing water to pass therethrough, creating a permeate. The water which continues to flow across the membrane becomes more saturated with contaminants and salts, and is known as the concentrate.

The concentrate may then be directed into a second reverse osmosis sub-module 50, to reduce water wastage, and the same process applies. The concentrate from the second reverse osmosis sub-module 50 passes back to a drain valve 80, preferably a drain solenoid valve which includes a flow restrictor. This allows for a continuous flow to drain, whilst maintaining an adequate back pressure to permit optimal reverse osmosis to occur. An optimal permeate recovery rate may be of the order of 7 l/hr of permeate from each reverse osmosis sub-module 50.

Periodically, the drain valve 80 on the concentrate line opens to flush any impurities off the reverse osmosis sub-module 50 membranes, thereby extending membrane lifetime.

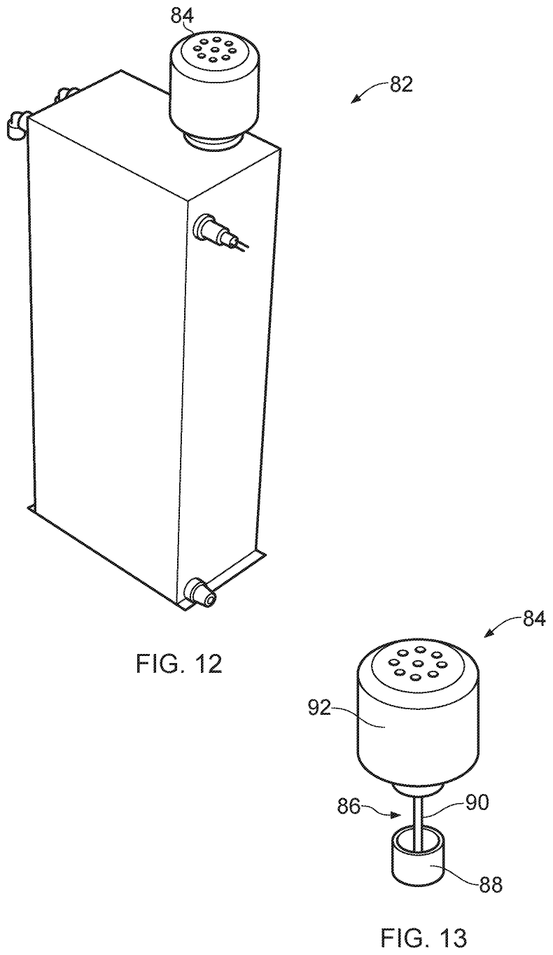

The permeates from the reverse osmosis sub-modules 50 may then be fed back to the sensors 44 to determine resistivity and therefore purity. This ends a first purification sub-module sequence, and the initially purified water can then be stored in at least one pure water reservoir 82, preferably formed from a plastics material such as polypropylene or polyethylene. An indicative embodiment of such a reservoir 82 is shown in FIG. 12. It is expected that the water quality would be of the order of 5.0 μS/cm at the end of the first purification sub-module sequence, which may be sufficient for some user applications. Preferably, the water reservoir 82 is stored within the main apparatus body 12, though an external tank could be considered, which may allow several reservoirs 82 to be present for large volume applications.

However, it is preferred that the purified water is re-purified immediately prior to dispensing, to mitigate the effects of impurities being introduced whilst in storage. Since the water reservoir or reservoirs 82 will have changing volumes of air above the water surface as water is dispensed, air will be drawn into the water reservoir 82 during dispensing. This air can introduce contaminants into the stored pure water.

An air vent filter 84 which is associated with the water reservoir 82 is illustrated in FIG. 13. The intention of this air vent filter 84 is to limit contamination of the water as air is introduced into the water reservoir 82. In this arrangement, the air vent filter 84 is filled with a combination of soda lime, activated carbon preferably in granular form, and an air filter, preferably having a pore dimension of or around 0.2 μm. This will allow air to be correctly filtered as it is drawn into the water reservoir as pure water is dispensed.

It is noted that this particular embodiment of air vent filter 84 includes a depending scoop, which is specifically designed to be a chlorine tablet scoop 86. The chlorine tablet scoop is formed as a cupped portion 88 attached to a stem 90 which extends into the water reservoir 82 below the main filter body 92. This allows for chlorine disinfection of the water reservoir 82 and internal manifolds to be performed without a technician needing to directly handle the chlorine tablet, which could be a source of contamination.

Once there is sufficient water in the water reservoir 82, a second purification sub-module sequence can be considered. This activates the recirculation pump 38, drawing purified water out of the water reservoir 82 and preferably through a strainer.

The water is pumped, preferably at a rate of 1.5 to 1.9 l/min into the purification module 18, via the high-pressure carbon filter 72, being an activated carbon sub-module, which again acts to screen out chlorine remnants in the purified water. The water is then passed through at least one, and preferably up to three, ion-exchange sub-modules 68 to remove further contaminants.

In addition, the second purification sub-module sequence may also include directing the water through an ultrafiltration sub-module 50, before passing into the UV lamp sub-module 60. At this point, the water can be returned to the water reservoir 82, and the recirculation process be repeated in a loop. This recirculation effectively polishes the purity of the water immediately before dispensing.

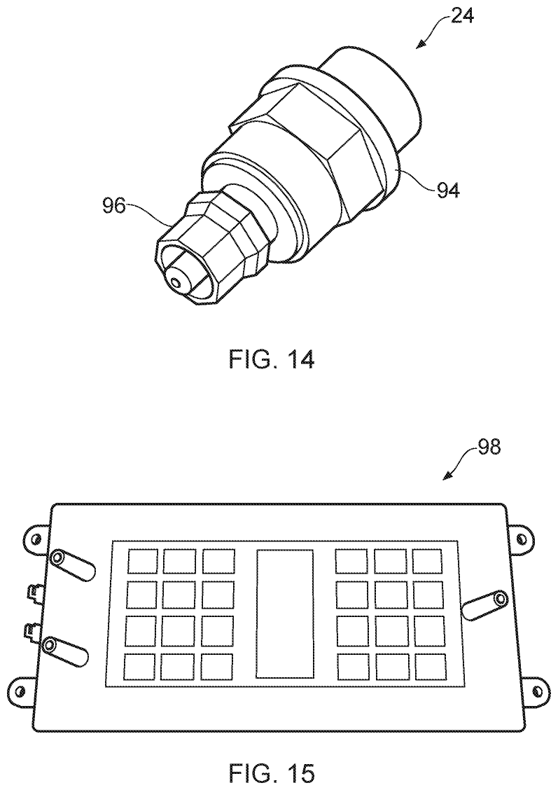

The water can then be directed towards the dispensing element 20 for dispensation, or can be directly extracted via the injection Luer connectors 24. An exemplary injection Luer connector 24 can be seen in FIG. 14. A main coupling 94 is provided which connects to the direct dispensing adaptor 22, as well as a syringe adaptor 96 which is directly connectable with an injection Luer syringe. A user can directly engage the injection Luer syringe with the syringe adaptor 96 to minimise contact of the purified water with the atmosphere when dispensing.

Preferably, there is a point-of-use filter which is attached at or adjacent to at least one of the dispensing element 20 or the direct dispensing adapter 22 as a final means of filtering the purified water.

The user may determine which dispensation option to choose via the control panel 34. Pure water can be directed towards the chosen dispensation route, either the dispensing element 20 or the direct dispensing adapter 22, from the water reservoir 82 via a non-return valve. This enables a head of pressure to push the water out and thereby prevent a Venturi effect as water crosses the valve ports which might otherwise draw air into the system.

Other additional advantageous features of the present water purification apparatus 10 are discussed hereafter.

FIG. 15 shows an electrolysis module 98 which may be used to attempt to eliminate the use of chlorine tablets completely from the water purification apparatus 10. The electrolysis module 98 is linked to a container which contains brine, and the electrolysis process therefore generates chlorine for disinfection purposes. Since chlorine tablets are eliminated in this scenario, the likelihood of contamination via their addition is removed.

It may also be possible to incorporate a hot water disinfection system as part of the water purification apparatus 10. This would completely eliminate the need for chemical, that is, chlorine-based, disinfection. The water treatment loop of the water purification apparatus 10 can be cleaned by increasing the water temperature to at least 85° C., using a heating element in a hot water tank. The heated water can then be flushed through the various internal water pathways until disinfection is complete. However, there may be a need to isolate the purification module 18, to protect the purification media from thermal degradation. Additionally, the pipe manifolds of the water purification apparatus 10 would need to be provided so as to be thermally resistant. Where a hot water tank is provided, an associated thermistor 100 may also be included for providing temperature control. This thermistor 100 may couple to the controller 36.

It may also be important, in certain circumstances, to provide a cooling manifold, particularly for laboratories in hot countries or those without limited access to temperature control facilities. In particular, the cooling manifold would be incorporated into the purification module 18, and this could be achieved using the concentrate water which is output from the reverse osmosis sub-modules 50. Since this water is usually cool, having been provided by a local municipal network from underground pipes, the concentrate can be channelled through the purification module 18 to maintain a manageable operation temperature, and in particular, drawing thermal energy away from the water purification sub-modules.

The purification media of the water purification apparatus 10 are capable of being recycled and regeneration, typically via return of the purification module 18 to a regeneration station. This method can be summarised as follows.

The purification module 18 can be removed from the main apparatus body 12. Each of the plurality of water purification sub-modules are then recycled or regenerated. The purification module 18 is then reattached to the main apparatus body 12 for subsequent operation. For the recycling and regeneration step, a purification medium is removed from a sub-module vessel 52, and the purification medium is regenerated or recycled. In the meantime, the sub-module vessel 52 is cleaned and sterilized, in addition to any of the accompanying sealing assemblies, and the plurality of water purification sub-modules are then reassembled by insertion of regenerated or recycled purification medium into the respective sub-module vessels 52.

It will be appreciated that any or all of the water purification sub-modules could be included in any configuration in accordance with the user's needs. The examples provided above are therefore indicative of one, relatively complex, purification assembly, and others will be apparent to the skilled user.

Typically, different water purification sub-modules will be provided. However, it will be appreciated that for some user requirements that a plurality of sub-modules may be provided of the same type, for instance, a plurality of ion-exchange sub-modules in a single purification module.

Hereafter are presented some definitions of the terms used in the present application.

Activated carbon, also known as activated charcoal, is a crude form of graphite, having a random, imperfect structure which is highly porous over a broad range of pore sizes. This creates a large surface area allowing the carbon to adsorb a wide range of compounds. Activated carbon has extremely high physical adsorption characteristics, having a potential surface area exceeding 1000 m²/g.

Reverse osmosis is a water purification technology that uses a semi-permeable membrane to remove ions, molecules, and larger particles from water. An applied pressure is used to overcome osmotic pressure. Reverse osmosis can remove many types of dissolved and suspended species from water, including bacteria. The result is that the solute is retained on the pressurized side of the membrane, and the pure solvent passes through to the other side.

An ion-exchange resin or polymer is a material which acts as a medium for ion exchange. It is formed as an insoluble matrix, usually in the form of microbeads, capable of trapping ions from the water in exchange for existing ions on the medium. Ion-exchange resins are generally classified by the type of ion supported by the resin, and in this instance, either strong base or weak base ion exchange resins may be considered. Typically, weak base ion exchange resins are more readily regenerated, and therefore may be preferable to use in the present invention, though some strong base resins can be regenerated and may therefore be appropriate in the purification module.

Ultrafiltration is a type of membrane filtration in which forces like pressure or concentration gradients lead to a separation through a semipermeable membrane. Suspended solids and solutes of high molecular weight are retained in a so-called retentate, while water and low molecular weight solutes pass through the membrane in the so-called permeate or filtrate. This separation process is used for concentrating and purifying macromolecular (10³-10⁶ Da) solutions, particularly protein solutions. It is similar in concept to microfiltration, with the difference purely being in the size of particles which can be filtered, and therefore microfiltration can be considered an analogue of ultrafiltration.

UV treatment, also known as ultraviolet germicidal irradiation is a disinfection method that used short-wavelength ultraviolet (UV-C) light to kill or inactivate microorganisms by destroying nucleic acids.

Hot water disinfection is used to clean the tank and ultrafiltration water filter. The temperature is raised to 85° C. to kill any bacterial colonies that may reside in the ultrafiltration membrane and/or tank storage facility.

A point-of-use filter is a filter which is used immediately before the point of use, and may be a commercial off-the-shelf product. Typically, this will be a hydrophilic membrane, such as nylon, having a 0.2 μm filter, and which provided excellent flow rates therethrough.

It is therefore possible to provide a water purification apparatus which significantly reduces the waste output associated with this industry in the art, by eliminating or reducing the need for disposable purification and filtration cartridges. The entire purification module is removable from the apparatus which allows it to be remotely disassembled, and then the purification media recycled or regenerated. Furthermore, this also reduces the equipment burden on the user, since a single water purification apparatus can be used for various different tasks, by replacement of the type of purification module.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A water purification apparatus for dispensing pure water, the water purification apparatus comprising:
a main apparatus body having at least one main fluid inlet and at least one main fluid outlet;
a dispenser adapted to dispense pure water from the water purification apparatus; and
a purification module which is releasably engagable with the main apparatus body, the purification module comprising a plurality of water purification sub-modules, a support framework, an inlet manifold in fluid communication with the plurality of water purification sub-modules and which is connectable to the at least one main fluid outlet of the main apparatus body, and an outlet manifold which is fluidly engagable with the dispenser;
wherein at least one of the plurality of water purification sub-modules is provided having a modular construction, comprising a removable vessel into which purification media can be inserted, and
the or each removable vessel being mounted to and sealed via the support framework.

2. The water purification apparatus of claim 1, wherein the plurality of water purification sub-modules comprises at least two of: an activated carbon sub-module; a reverse osmosis sub-module; an ion-exchange sub-module; an ultra-filtration sub-module; a UV lamp sub-module.

3. The water purification apparatus of claim 2, wherein the purification module comprises a first purification sub-module sequence and a second purification sub-module sequence.

4. The water purification apparatus of claim 3, wherein the first purification sub-module sequence comprises a plurality of said water purification sub-modules in the sequence of: an activated carbon sub-module; a first reverse osmosis sub-module; and a second reverse osmosis sub-module.

5. The water purification apparatus of claim 3, wherein the second purification sub-module sequence comprises a plurality of said water purification sub-modules in the sequence of: an activated carbon sub-module; and at least one ion-exchange sub-module.

6. The water purification apparatus of claim 5, wherein the second purification sub-module sequence further comprises a UV lamp sub-module; and an ultra-filtration sub-module.

7. The water purification apparatus of claim 3, wherein the second purification sub-module sequence forms a recirculation loop.

8. The water purification apparatus of claim 7, further comprising a water reservoir which is in fluid communication with the recirculation loop.

9. The water purification apparatus of claim 8, further comprising an air vent filter engagable with a top of the water reservoir, wherein the air vent filter comprises a chlorine tablet scoop.

10. The water purification apparatus of claim 1, further comprising a direct dispensing adaptor downstream of the outlet manifold for extraction of pure water following purification via the purification module, the direct dispensing adaptor comprising at least one injection connector.

11. (canceled)

12. The water purification apparatus of claim 1, wherein the purification module comprises a casing which encloses each of the plurality of water purification sub-modules.

13. The water purification apparatus of claim 1, wherein the support framework comprises a cassette having the plurality of vessels supported thereon.

14. The water purification apparatus of claim 1, further comprising any or all of: an electrolysis module being configured to generate chlorine for disinfection of the water purification apparatus; a peristaltic pump associated with the dispenser for metering pure water from the water purification apparatus; a hot water reservoir, the hot water reservoir being fluidly communicable with the water purification apparatus to permit thermal sanitisation thereof; and a cooling manifold in the water purification apparatus.

15. (canceled)

16. (canceled)

17. The water purification apparatus of claim 1, further comprising a manifold adaptor which is insertable to connect the or each main fluid outlet of the main apparatus body and the inlet manifold of the purification module.

18. (canceled)

19. The water purification apparatus of claim 1, wherein the purification module is releasably engagable with a front of the main apparatus body.

20. The water purification apparatus of claim 1, further comprising one or more locators on or at the support framework for mounting the removable vessels.

21. The water purification apparatus of claim 1, wherein the support framework comprises at least one plate for sealing all of the removable vessels in position in the purification module.

22. A method of regenerating the water purification apparatus of claim 1 further comprising purification medium, the method comprising the steps of:
a] removing the purification module from the main apparatus body;
b] recycling or regenerating each of the plurality of water purification sub-modules; and
c] re-attaching the or another said purification module to the main apparatus body.

23. The method of claim 22, wherein step b], for each of the plurality of water purifications sub-modules, comprises the sub-steps of:
b1] removing the purification medium from each sub-module vessel;
b2] regenerating or recycling each purification medium;
b3] cleaning and sterilizing each sub-module vessel; and
b4] reassembling the plurality of water purification sub-modules by inserting the regenerated or recycled purification medium into the respective sub-module vessels.

24. A purification module for a water purification apparatus, the purification module comprising:
a plurality of water purification sub-modules, wherein at least one of the plurality of water purification sub-modules is provided having a modular construction, comprising a removable vessel into which purification media can be inserted;
a support framework, the or each removable vessel being mounted to and sealed via the support framework;
an inlet manifold in fluid communication with the plurality of water purification sub-modules and which is connectable to at least one main fluid outlet of a main apparatus body of a water purification apparatus; and
an outlet manifold which is adapted to be fluidly engagable with a dispenser of the water purification apparatus.

25. (canceled)
